(19) United States
(12) Patent Application Publication
(10) Pub. No.: US 2007/0166202 A1
(43) Pub. Date: Jul. 19, 2007

(54) LIQUID CONTAINER

(76) Inventor: Hitotoshi Kimura, Matsumoto-shi (JP)

Correspondence Address: STROOCK & STROOCK & LAVAN LLP, 180 MAIDEN LANE, NEW YORK, NY, 10038, US

(21) Appl. No.: 11/623,439

(22) Filed: Jan. 16, 2007

(30) Foreign Application Priority Data
Jan. 16, 2006 (JP) P2006-008042

(51) Int. Cl. B01L 3/00

(52) U.S. Cl. 422/102

(57) ABSTRACT

A liquid container includes: a pressure chamber in which pressurized fluid is introduced; a liquid containing chamber that is pressurized due to the pressurized fluid to be introduced into the pressure chamber so as to discharge liquid stored therein; and a liquid detection device for detecting a liquid containing amount in the liquid containing chamber, wherein the liquid detection device has a liquid detection chamber that includes a liquid inlet port communicating with the liquid containing chamber and a liquid outlet port communicating with a liquid supply port for supplying the liquid to an external liquid consuming apparatus, a moving member that is movable according to a liquid containing amount in the liquid detection chamber, and a detection unit that detects a movement state in which the moving member moves to a predetermined position, and wherein the liquid detection device is provided in the pressure chamber.

### BACKGROUND

1. Technical Field

The present invention relates to a liquid container that supplies a predetermined liquid to a liquid consuming apparatus, for example, a liquid ejecting head ejecting a predetermined amount of liquid droplet.

2. Related Art

A liquid ejecting head of a textile printing apparatus, a micro dispenser, or a commercial recording apparatus that requires ultrahigh printing quality receives a liquid ejected from a liquid container. However, if the liquid ejecting head operates in a state where the liquid is not supplied, idle printing occurs, and thus the liquid ejecting head is likely to be damaged. In order to prevent this problem, it is necessary to monitor a liquid residual quantity in the container.

As the recording apparatus, there are suggested various apparatuses that have a liquid detection device for detecting a liquid containing amount in a liquid containing chamber, that is, an ink residual quantity in an ink cartridge as a liquid container.

As the specific structure of the liquid detection device, there is suggested an ink cartridge having an ink containing chamber that is provided in an airtight space and is pressurized by a pressure due to a pressurized fluid (typically, air) to be supplied from the outside into the airtight space so as to discharge ink stored therein. The ink cartridge has a liquid detection chamber that is interposed between a discharge port of the ink containing chamber and an ink supply port connected to a recording apparatus. Here, the volume of the liquid detection chamber changes according to a discharge amount of ink from the discharge port of the ink containing chamber. In addition, the liquid detection chamber is formed outside the airtight space that is blocked from the pressure of the pressurized fluid (for example, see Patent Document 1).

The liquid detection chamber of the liquid detection device having the above structure has a flexible wall, such as a diaphragm or the like, as a chamber wall. Accordingly, even though sufficient ink remains in the ink containing chamber, when the pressure due to the pressurized fluid is not applied to the ink containing chamber and an ink liquid is not discharged from the ink containing chamber, the volume of the liquid detection chamber is minimized. Then, if the ink liquid is discharged from the ink containing chamber by a predetermined pressure operation of the pressurized fluid, the volume of the liquid detection chamber increases according to the amount of discharged ink.

Therefore, the ink residual quantity (ink containing amount) in the ink containing chamber can be detected by monitoring a change in volume of the liquid detection chamber upon the pressure operation of the pressurized fluid.

Patent Document 1: JP-A-2004-306604

However, in the above-described liquid detection device, when ink is not discharged from the ink containing chamber, the flexible wall, such as a diaphragm or the like, constituting the chamber wall of the liquid detection chamber is urged by an appropriate urging unit in a direction in which the volume of the liquid detection chamber decreases, such that the liquid detection chamber is kept to the minimum volume. Then, whenever ink is discharged from the ink containing chamber, the flexible wall, such as a diaphragm or the like, frequently repeats deformation to expand the volume of the liquid detection chamber. Accordingly, the flexible wall, such as a diaphragm or the like, needs to be formed of an expensive material having high durability. High cost of the liquid detection device is accompanied by an increase in cost of the liquid container.

### SUMMARY

An advantage of some aspects of the invention is to provide a liquid container that, since a flexible wall of a liquid detection chamber for detecting a liquid containing amount does not frequently repeat deformation, enables the use of a cheap material having lower durability for the flexible wall of the liquid detection chamber so as to implement a liquid detection device for detecting the liquid containing amount at low cost, thereby reducing costs of the liquid container. The advantage can be attained as at least one of the following aspects:

(1) According to a first aspect of the invention, a liquid container includes: a pressure chamber in which pressurized fluid is introduced; a liquid containing chamber that is pressurized due to the pressurized fluid to be introduced into the pressure chamber so as to discharge liquid stored therein; and a liquid detection device for detecting a liquid containing amount in the liquid containing chamber, wherein the liquid detection device has a liquid detection chamber that includes a liquid inlet port communicating with the liquid containing chamber and a liquid outlet port communicating with a liquid supply port for supplying the liquid to an external liquid consuming apparatus, a moving member that is movable according to a liquid containing amount in the liquid detection chamber, and a detection unit that detects a movement state in which the moving member moves to a predetermined position, and wherein the liquid detection device is provided in the pressure chamber space.

According to this structure, since the liquid detection device is provided in the pressure chamber that is pressurized by the pressurized fluid, the moving member that changes the volume of the liquid detection chamber of the liquid detection device may be urged in a direction distant from a bottom wall of the liquid detection chamber facing the moving member so as to maximize the volume of the liquid detection chamber, unlike a known structure in which the liquid detection device is provided outside the pressure chamber. An urging force F against the moving member at that time is set such that, when a pressure force by the pressurized fluid is P and an internal pressure of the liquid detection chamber by the pressure of a liquid flowing into the liquid detection chamber to be then filled therein by the pressure of the pressurized fluid is p1, the relationship P=F+p1 is established.

Accordingly, if the liquid containing amount in the liquid containing chamber decreases, when a predetermined pressure operation by the pressurized fluid is performed, the amount of a liquid flowing from the liquid containing chamber into the liquid detection chamber decreases. Therefore, the actual internal pressure by the pressure of the liquid in the liquid detection chamber becomes p2 that is smaller than the prescribed internal pressure p1.

That is, if the liquid containing amount in the liquid containing chamber decreases and the amount of the liquid flowing from the liquid containing chamber into the liquid detection chamber upon the pressure operation decreases accordingly, a total urging force (F+p2) to be applied to the moving member in the liquid detection chamber becomes smaller than the pressure force P by the pressurized fluid according to the relationship (F+p2)<(F+p1)=P. Then, the moving member moves in a direction in which the volume of the liquid detection chamber decreases.

As a result, when the detection unit detects the movement of the moving member to the predetermined position, the liquid containing amount in the liquid containing chamber can be detected.

In the liquid detection device having the above structure, the liquid detection chamber is initially set to the maximum internal volume and then the internal volume of the liquid detection chamber gradually decreases as the liquid in the liquid containing chamber consumes. Then, as the liquid in the liquid containing chamber is exhausted, the internal volume of the liquid detection chamber is minimized. Therefore, the flexible wall that supports the moving member of the liquid detection chamber is gradually deformed in a direction in which the internal volume of the liquid detection chamber gradually decreases.

That is, the occurrence of large deformation on the basis of a change in internal volume of the liquid detection chamber from the maximum to the minimum is one time until the liquid in the liquid containing chamber is exhausted. Accordingly, the flexible wall of the liquid detection chamber does not frequently repeat the large deformation, unlike the known structure where the liquid detection device is provided outside the pressure chamber. Therefore, a cheap material having lower durability can be used for the flexible wall of the liquid detection chamber. As a result, the liquid detection device for detecting the liquid containing amount can be implemented at low cost, thereby reducing costs of the liquid container.

(2) According to a second aspect of the invention, in the liquid container according to the first aspect of the invention, the liquid detection chamber may be formed by sealing an opening formed at its upper surface with a film that is deformable according to the liquid containing amount of the liquid detection chamber, and the detection unit may be disposed at the bottom of the liquid detection chamber.

According to this structure, the film that seals the opening serves as the flexible wall for enabling a volume change of the liquid detection chamber. Therefore, the liquid detection chamber having a volume change characteristic (compliance) can be simply formed at low cost.

(3) According to a third aspect of the invention, in the liquid container according to the first or second aspect of the invention, the moving member may move by the deformation of the film corresponding to a change in liquid containing amount of the liquid detection chamber.

According to this structure, what is necessary is that the moving member is bonded to the film. Therefore, a complex part for moving the moving member corresponding to the change in liquid containing amount is not required. As a result, costs can be reduced with the simple structure.

(4) According to a fourth aspect of the invention, in the liquid container according to any one of the first to third aspects of the invention, the detection unit may be a piezoelectric detection unit that has a concave portion formed in the liquid detection chamber so as to form a closed space in cooperation with one surface parallel to a horizontal surface of the moving member in a state where the moving member moves to the predetermined position according to the liquid containing amount. The piezoelectric detection unit may apply vibration to the concave portion and detect a free vibration state according to the applied vibration.

According to this structure, if the vibration is applied to the concave portion by the piezoelectric detection unit, the state of the free vibration (residual vibration) changes corresponding to the change in volume of the liquid detection chamber according to the displacement of the moving member facing the concave portion. Therefore, a state where the moving member reaches a regular position (that is, the liquid residual quantity reaches a regular amount) can be detected with high accuracy by detecting a frequency of the free vibration.

(5) According to a fifth aspect of the invention, in the liquid container according to the fourth aspect of the invention, the moving member may have, in a region facing a vibration surface of the piezoelectric detection unit, a surface substantially parallel to the vibration surface.

According to this structure, a vibration space, to which the vibration is applied by the piezoelectric detection unit, can be easily formed in the airtight space suitable for the application of the vibration in cooperation with the moving member.

(6) According to a sixth aspect of the invention, in the liquid container according to any one of the first to fifth aspects of the invention, the moving member may be urged by an urging unit in a direction opposite to a direction in which the piezoelectric detection unit is disposed.

According to this structure, with the urging unit, the moving member that is initially set to be distant from the piezoelectric detection unit to the maximum such that the internal volume of the liquid detection chamber is maximized gradually approaches the piezoelectric detection unit as the liquid containing amount in the liquid containing chamber decreases and the pressure of the liquid in the liquid detection chamber decreases accordingly. Then, if the liquid in the liquid containing chamber is exhausted, the moving member is closest to the piezoelectric detection unit. Therefore, when the free vibration that changes by the positional displacement of the moving member is detected by the piezoelectric detection unit, the change in liquid containing amount or presence/absence of the liquid can be reliably detected.

(7) According to a seventh aspect of the invention, in the liquid container according to the sixth aspect of the invention, the urging unit may be formed of an elastic member.

According to this structure, the urging force by the urging unit can be simply increased or decreased by changing quality of the elastic member or the like. Then, by increasing or decreasing the urging force, a time at which the moving member closes the concave portion can be changed, and thus a liquid residual quantity to be detected in the liquid detection chamber can be easily set and changed.

(8) According to an eighth aspect of the invention, in the liquid container according to any one of the first to seventh aspects of the invention, a time at which the moving member forms the closed space in cooperation with the concave portion may be set to a state where the liquid of the liquid containing chamber is exhausted.

(9) According to a ninth aspect of the invention, in the liquid container according to any one of the first to eighth aspects of the invention, a time at which the moving member forms the closed space in cooperation with the concave portion may be set to a state where the liquid of the liquid containing chamber is nearly exhausted.

According to the structure described in the eighth or ninth aspect of the invention, for example, when the liquid container is used as an ink cartridge, the piezoelectric detection unit of the liquid detection device can be efficiently used as an ink end detection mechanism for detecting that an ink residual quantity in the liquid containing chamber becomes zero, or an ink end detection unit for detecting a state where the ink residual quantity almost becomes zero.

In the liquid container according to the aspects of the invention, the liquid detection chamber of the liquid detection device is initially set to the maximum internal volume and then the internal volume of the liquid detection chamber gradually decreases as the liquid in the liquid containing chamber consumes. Then, as the liquid in the liquid containing chamber is exhausted, the internal volume of the liquid detection chamber is minimized. Therefore, the flexible wall that supports the moving member of the liquid detection chamber is gradually deformed in a direction in which the internal volume of the liquid detection chamber gradually decreases.

That is, the occurrence of large deformation on the basis of a change in internal volume of the liquid detection chamber from the maximum to the minimum is one time until the liquid in the liquid containing chamber is exhausted. Accordingly, the flexible wall of the liquid detection chamber does not frequently repeat the large deformation, unlike the known structure where the liquid detection device is provided outside the airtight space. Therefore, a cheap material having lower durability can be used for the flexible wall of the liquid detection chamber. As a result, the liquid detection device for detecting the liquid containing amount can be implemented at low cost, thereby reducing costs of the liquid container.

The present disclosure relates to the subject matter contained in Japanese patent application No. 2006-008042 filed on Jan. 16, 2006, which is expressly incorporated herein by reference in its entirety.

### BRIEF DESCRIPTION OF THE DRAWINGS

The invention will be described with reference to the accompanying drawings, wherein like numbers reference like elements.

FIG. 1 is a longitudinal cross-sectional view of a liquid container according to an embodiment of the invention in a state where a liquid remains in a liquid containing chamber and an airtight space is not pressurized.

FIG. 2 is a longitudinal cross-sectional view of a liquid container according to an embodiment of the invention in a state where a liquid remains in a liquid containing chamber and an airtight space is pressurized.

FIG. 3 is a longitudinal cross-sectional view of a liquid container according to an embodiment of the invention in a state where a liquid of a liquid containing chamber is exhausted and an airtight space is not pressurized.

### DESCRIPTION OF EXEMPLARY EMBODIMENTS

Hereinafter, a preferred embodiment of a liquid container according to the invention will be described in detail with reference to the drawings.

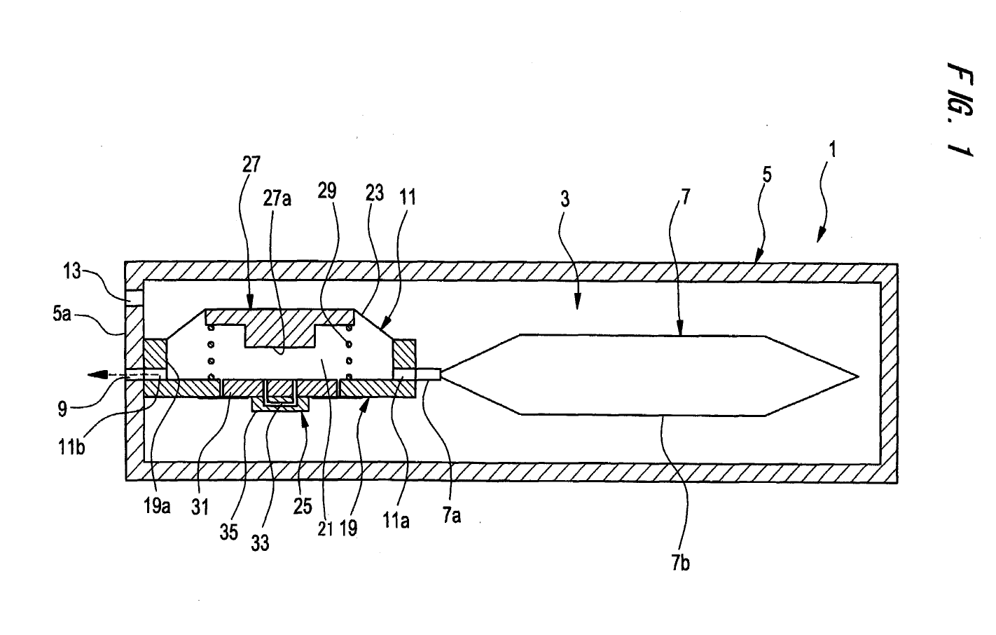

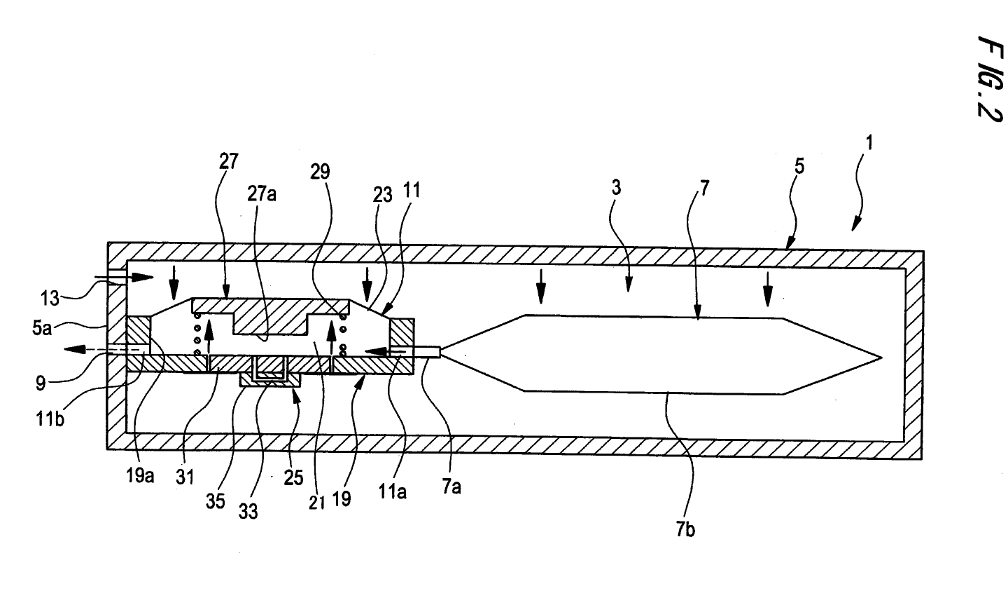

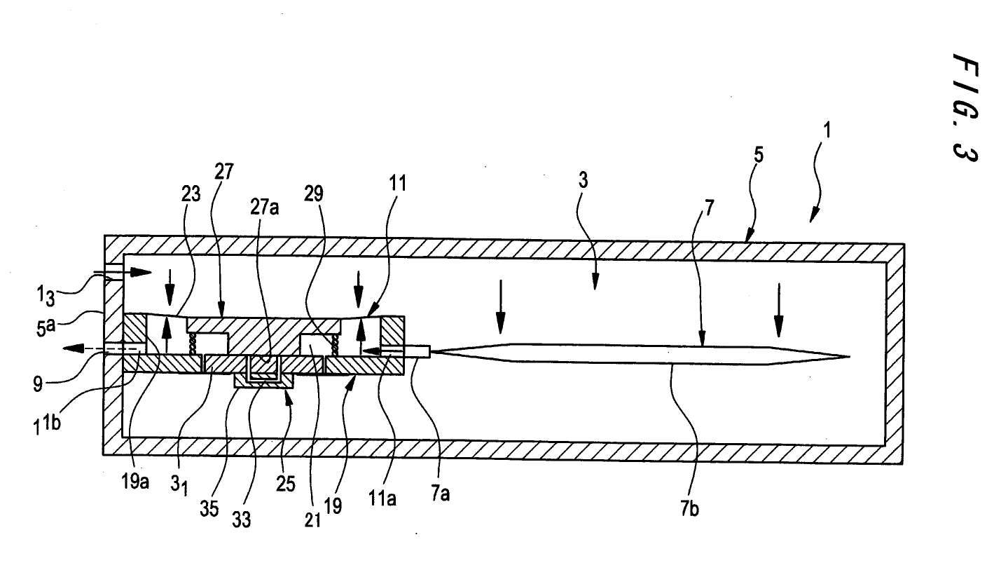

FIG. 1 is a longitudinal cross-sectional view of a liquid container according to an embodiment of the invention in a state where a liquid remains in a liquid containing chamber and an airtight space is not pressurized. FIG. 2 is a longitudinal cross-sectional view of a liquid container according to an embodiment of the invention in a state where a liquid remains in a liquid containing chamber and an airtight space is pressurized. FIG. 3 is a longitudinal cross-sectional view of a liquid container according to an embodiment of the invention in a state where a liquid of a liquid containing chamber is exhausted and an airtight space is not pressurized.

A liquid container 1 according to this embodiment is an ink cartridge that is detachably mounted on a cartridge mounting portion of an ink jet recording apparatus and supplies ink to a recording head (liquid ejecting head) provided in the recording apparatus.

The liquid container 1 includes a container main body 5 that partitions an airtight space 3 to be pressurized by a pressure unit, a liquid containing chamber 7 that stores ink, is accommodated in the airtight space (pressure chamber) 3, and discharges ink stored therein from a discharge port 7a by pressure of the airtight space 3, a liquid supply port 9 that is formed to pass through a partition 5a of one end of the container main body 5 so as to supply ink to a recording head as an external ink liquid consuming apparatus, and a liquid detection device 11 that is interposed between the liquid containing chamber 7 and the ink supply port 9 in the airtight space 3 so as to detect an ink residual quantity. In the invention, the airtight space may be a space that can be sealed as far as the space exerts its function when the liquid container 1 is attached to the liquid consuming apparatus.

The container main body 5 is a boxlike casing and has a pressure port 13 formed at the partition 5a of one end in a 6-faced partition forming the airtight space 3, in addition to the ink supply port 9. The pressure port 13 is a path through which the pressure unit (not shown) supplies pressurized air.

The liquid containing chamber 7 is a so-called ink pack that has a pouch body 7b formed by adhering edges of aluminum-laminated multilayer films, on which an aluminum layer is laminated on a flexible resin film, to each other. A cylindrical discharge port 7a, to which an ink inlet port 11a of the liquid detection device 11 is connected, is bonded to one end of the pouch body 7b. Since the aluminum-laminated multilayer films are used, a high gas barrier property is secured.

The liquid containing chamber 7 and the liquid detection device 11 are connected to each other by engaging the ink inlet port 11a with the discharge port 7a. That is, the liquid containing chamber 7 and the liquid detection device 11 can be detached from each other by releasing the engagement of the discharge port 7a and the ink inlet port 11a.

Ink is filled into the liquid containing chamber 7 in advance at a high degree of deaeration before the ink detection unit 11 is connected.

The ink detection device 11 includes a detection device case 19 that has a concave space 19a communicating the ink inlet port 11a connected to the discharge port 7a of the liquid containing chamber 7 and an ink outlet port 11b connected to the ink supply port 9, a flexible film 23 that seals an opening at an upper surface of the concave space 19a so as to partition a liquid detection chamber (liquid storage portion) 21, a vibration detection unit 25 that is provided at the bottom of the concave space 19a, a moving member 27 that is fixed to an inner surface of the flexible film 23 to face the vibration detection unit 25 by an adhesive or the like, and a pressing spring 29 that is compressed between the moving member 27 and the bottom of the concave space 19a and urges the moving member 27 and the flexible film 23 in a direction in which the volume of the liquid detection chamber 21 increases.

In the detection device case 19, the ink inlet port 11a is integrally formed at one end of a peripheral wall partitioning the concave space 19a, and the ink outlet port 11b that is connected to the ink supply port 9 is formed to pass through a peripheral wall facing the ink inlet port 11a.

Though not shown, a valve mechanism is provided in the ink supply port 9. The valve mechanism opens a flow passage when the ink cartridge is mounted on the cartridge mounting portion of the ink jet recording apparatus and an ink supply needle provided in the cartridge mounting portion is inserted into the ink supply port 9.

As shown in FIG. 3, the vibration detection unit 25 of the ink detection unit 11 includes a bottom plate 31 that comes into close contact with the moving member 27 when ink of the liquid containing chamber 7 is exhausted and the moving member 27 is pressed down against the pressing spring 29 by a pressure of the pressurized fluid to be supplied from the pressure port 13 into the airtight space 3, an ink guide path 33 that is a concave portion formed in the bottom plate 31, and a piezoelectric detection unit 35 that applies vibration to the ink guide path 33 and detects a free vibration state according to the applied vibration. Accordingly, presence/absence of ink (ink residual quantity) is detected from the free vibration state (amplitude of residual vibration or change in frequency) that changes according to whether or not the ink guide path 33 is covered with the moving member 27 and whether or not bubbles are mixed.

An urging direction of the pressing spring 29 is a direction in which the volume of the liquid detection chamber 21 increases, as described above, and a direction opposite to a direction on which the piezoelectric detection unit 35 is disposed.

The ink guide path 33 that is the concave portion formed in the bottom plate 31 is partitioned in a closed space blocked from the liquid detection chamber 21 in a state where the moving member 27 comes into close contact with the bottom plate 31, as shown in FIG. 3. Further, as shown in FIGS. 1 and 2, in a state where the moving member 27 is separated from the bottom plate 31, the ink guide path 33 communicates with the liquid detection chamber 21.

An urging force F of the pressing spring 29 to the moving member 27 is set such that, when a pressure force by the pressurized fluid to be supplied to the airtight space 3 is P and an internal pressure of the liquid detection chamber 21 by the pressure of ink flowing from the liquid containing chamber 7 into the liquid detection chamber 21 to be then filled therein by the pressure of the pressurized fluid is p1, the relationship P=F+p1 is established.

If an ink containing amount in the liquid containing chamber 7 decreases, when a predetermined pressure operation by the pressurized fluid is performed, the amount of ink flowing from the liquid containing chamber 7 into the liquid detection chamber 21 decreases. Accordingly, the actual internal pressure by the pressure of ink in the liquid detection chamber 21 becomes p2 that is smaller than the prescribed internal pressure p1.

That is, when the airtight space 3 is pressurized by the pressurized fluid and enough ink remains in the liquid containing chamber 7, the liquid detection chamber 21 is expanded to have the maximum volume by the urging force of the pressing spring 29.

Thereafter, if the ink containing amount in the liquid containing chamber 7 decreases and the amount of ink flowing from the liquid containing chamber 7 into the liquid detection chamber 21 upon the pressure operation decreases accordingly, a total urging force (F+p2) to be applied to the moving member 27 in the liquid detection chamber 21 becomes smaller than the pressure force P by the pressurized fluid according to the relationship (F+p2)<(F+p1)=P. Then, the moving member 27 moves in a direction in which the volume of the liquid detection chamber 21 decreases.

FIG. 2 shows a state where, with the supply of pressurized air to the airtight space 3, the liquid containing chamber 7 and the liquid detection device 11 are pressurized, and an ink liquid in the liquid containing chamber 7 is supplied to the ink supply port 9 through the liquid detection chamber 21.

If ink of the liquid containing chamber 7 is exhausted and, even though the airtight space 3 is pressurized by pressurized air, ink is not supplied from the liquid containing chamber 7 to the liquid detection chamber 21, an urging force in the liquid detection chamber 21 to the moving member 27 is only the urging force of the pressing spring 29. Then, the moving member 27 is pressed against the bottom of the concave space 19a, that is, the vibration detection unit 25, by an external pressure by pressurized air. A lower surface 27a of the moving member 27 is parallel to the surface of the bottom plate 31 (that is, parallel to the horizontal surface). The lower surface 27a of the moving member 27 comes into close contact with the surface of the bottom plate 31, and thus the ink guide path 33 is partitioned in the closed space.

In this embodiment, a time at which the moving member 27 comes into close contact with the bottom plate 31 by the decrease in ink containing amount in the liquid detection chamber 21 and the ink guide path 33 is formed in the closed space is set to a state where the liquid in the liquid containing chamber 7 is exhausted.

The flexible film 23 functions as a diaphragm that applies displacement to the moving member 27 according to the pressure of ink to be supplied to the liquid detection chamber 21. In order to enable a very little change in pressure of ink to be detected and to improve detection accuracy, what is necessary is that the flexible film 23 has enough flexibility.

In the above-described liquid container 1, if the liquid containing amount in the liquid detection chamber 21 is equal to or less than a regular amount, the moving member 27 comes into close into contact with the bottom plate 31 having the ink guide path 33 that is the concave portion, and the ink guide path 33 as a vibration reaction region becomes a substantially closed space. Accordingly, a change in free vibration state markedly appears, and thus a time or a state where the liquid residual quantity in the liquid containing chamber 7 or the liquid detection chamber 21 reaches a predetermined level can be accurately and reliably detected.

In the liquid detection device 11 of this embodiment, the liquid detection chamber 21 is initially set to the maximum internal volume, and the internal volume of the liquid detection chamber 21 gradually decreases as ink in the liquid containing chamber 7 consumes. Then, if ink in the liquid containing chamber 7 is exhausted, the internal volume of the liquid detection chamber 21 is minimized. Accordingly, the flexible film 23 that serves as a flexible wall for supporting the moving member 27 of the liquid detection chamber 21 is gradually deformed in a direction in which the internal volume of the liquid detection chamber 21 gradually decreases.

That is, the occurrence of large deformation on the basis of a change in internal volume of the liquid detection chamber 21 from the maximum to the minimum is one time until the liquid in the liquid containing chamber 7 is exhausted. Accordingly, the flexible film 23 as the flexible wall of the liquid detection chamber 21 does not frequently repeat the large deformation, unlike the known structure where the liquid detection device is provided outside the airtight space 3. Therefore, a cheap material having lower durability can be used for the flexible film 23 as the flexible wall of the liquid detection chamber 21. As a result, the liquid detection device 11 for detecting the liquid containing amount can be implemented at low cost, thereby reducing costs of the liquid container 1.

In the liquid detection device 11 of the liquid container 1 of this embodiment, the flexible film 23 is bonded to the detection device case 19, in which the concave space 19a having an opened upper surface is formed, so as to seal the opening of the upper surface of the concave space 19a, thereby partitioning the liquid detection chamber 21. Further, since the flexible film 23 sealing the opening of the concave space 19a is a flexible wall that enables a change in volume of the liquid detection chamber 21, the liquid detection chamber 21 having a volume change characteristic (compliance) can be simply formed at low cost.

In the liquid detection device 11 of the liquid container 1 of this embodiment, the moving member 27 that is displaced toward the bottom of the liquid detection chamber 21 corresponding to a decrease in volume of the liquid detection chamber 21 is merely bonded to the flexible film 23 constituting a part of the partition of the liquid detection chamber 21. Accordingly, a complex part for moving the moving member 27 corresponding to a change in liquid containing amount is not required. As a result, costs can be reduced with the simple structure.

In the liquid detection device 11 of the liquid container 1 of this embodiment, if the vibration is applied to the ink guide path 33 as the concave portion by the piezoelectric detection unit 35, the free vibration (residual vibration) state changes corresponding to the change in volume of the liquid detection chamber 21 according to the displacement of the moving member 27 facing the ink guide path 33 as the concave portion. Therefore, a state where the moving member 27 reaches a regular position (that is, the liquid residual quantity reaches a regular amount) can be detected with high accuracy by detecting a frequency of the free vibration.

In the liquid detection device 11 of the liquid container 1 of this embodiment, if the moving member 27 moves to a predetermined position (a position at which the moving member 27 comes into close contact with the bottom plate 31) corresponding to the liquid containing amount, the lower surface 27a that is parallel to the horizontal surface of the moving member 27 comes into close contact with the surface of the bottom plate 31. Then, the moving member 27 reliably blocks the opening of the ink guide path 33. Accordingly, the ink guide path 33 serving as a vibration space, to which the piezoelectric detection unit 35 applies the vibration, can be reliably formed in the airtight space suitable for the application of the vibration.

In the liquid detection device 11 of the liquid container 1 of this embodiment, the moving member 27 is urged by the pressing spring 29 as an urging unit in a direction opposite to a direction in which the piezoelectric detection unit 35 is disposed.

Accordingly, with the pressing spring 29, the moving member 27 that is initially set to be distant from the piezoelectric detection unit 35 to the maximum such that the internal volume of the liquid detection chamber 21 is maximized gradually approaches the piezoelectric detection unit 35 as the liquid containing amount in the liquid containing chamber 7 decreases and the pressure of the liquid in the liquid detection chamber 21 decreases accordingly. Then, if the liquid in the liquid containing chamber 7 is exhausted, the moving member 27 is closest to the piezoelectric detection unit 35. Therefore, when the free vibration that changes by the positional displacement of the moving member 27 is detected by the piezoelectric detection unit 35, a change in liquid containing amount or presence/absence of the liquid can be reliably detected.

In the liquid detection device 11 of the liquid container 1 of this embodiment, as the urging unit that urges the moving member 27 in a direction distant from the piezoelectric detection unit 35, the pressing spring 29 formed of an elastic member is used.

Accordingly, the urging force of the pressing spring 29 can be simply increased or decreased by changing quality of the elastic member or the like. Then, by increasing or decreasing the urging force, a time at which the moving member 27 closes the concave portion can be changed, and thus a liquid residual quantity to be detected in the liquid detection chamber 21 can be easily set and changed.

In the liquid detection device 11 of the liquid container 1 of this embodiment, a time at which the moving member 27 forms the ink guide path 33 in the closed space in cooperation with the bottom plate 31 is set to a state where the liquid of the liquid containing chamber 7 is exhausted. Accordingly, for example, when the liquid container 1 is used as an ink cartridge, the piezoelectric detection unit 35 of the liquid detection device 11 can be efficiently used as an ink end detection mechanism for detecting that the ink residual quantity in the liquid containing chamber 7 becomes zero.

Moreover, a time at which the moving member 27 forms the ink guide path 33 in the closed space in cooperation with the bottom plate 31 may be set to a state where the liquid of the liquid containing chamber 7 is nearly exhausted.

In such a manner, for example, when the liquid container 1 is used as an ink cartridge, the piezoelectric detection unit 35 of the liquid detection device 11 can be efficiently used an ink end detection unit for detecting a state where the ink residual quantity in the liquid containing chamber 7 almost becomes zero.

In the above-described embodiment, the moving member 27 is fixed to the inner surface of the flexible film 23 by an adhesive or the like. However, the moving member 27 may not be fixed to the flexible film 23. For example, the moving member 27 may be kept to come into contact with the flexible film 23 by the urging force of the pressing spring 29 that urges the moving member 27 in a direction distant from the bottom plate 31.

The use of the liquid container according to the invention is not limited to the ink cartridge of the ink j et recording apparatus. For example, the liquid container of the invention is used for various liquid consuming apparatuses having a liquid ejecting head.

Specific examples of the liquid consuming apparatus having a liquid ejecting head include an apparatus having a color material ejecting head used in manufacturing color filters of a liquid crystal display or the like, an apparatus having an electrode material (conductive paste) ejecting head used in forming electrodes of an organic electroluminescent (EL) display or a surface emission display (FED), an apparatus having a bioorganic compound ejecting head used in manufacturing a bio-chip, an apparatus having a sample spraying head as a precision pipette, a textile printing apparatus, or a micro dispenser.

What is claimed is:

1. A liquid container comprising:
a pressure chamber in which pressurized fluid is introduced;
a liquid containing chamber that is pressurized due to the pressurized fluid to be introduced into the pressure chamber so as to discharge liquid stored therein; and
a liquid detection device for detecting a liquid containing amount in the liquid containing chamber,
wherein the liquid detection device has
a liquid detection chamber that includes a liquid inlet port communicating with the liquid containing chamber and a liquid outlet port communicating with a liquid supply port for supplying the liquid to an external liquid consuming apparatus,
a moving member that is movable according to a liquid containing amount in the liquid detection chamber, and
a detection unit that detects a movement state in which the moving member moves to a predetermined position, and
wherein the liquid detection device is provided in the pressure chamber.

2. The liquid container according to claim 1,
wherein the liquid detection chamber is formed by sealing an opening formed at its upper surface with a film that is deformable according to the liquid containing amount of the liquid detection chamber, and the detection unit is disposed at the bottom of the liquid detection chamber.

3. The liquid container according to claim 1,
wherein the moving member moves by the deformation of the film corresponding to a change in liquid containing amount of the liquid detection chamber.

4. The liquid container according to claim 1,
wherein the detection unit is a piezoelectric detection unit that has a concave portion formed in the liquid detection chamber so as to form a closed space in cooperation with one surface parallel to a horizontal surface of the moving member in a state where the moving member moves to the predetermined position according to the liquid containing amount, and
the piezoelectric detection unit applies vibration to the concave portion and detects a free vibration state according to the applied vibration.

5. The liquid container according to claim 4,
wherein the moving member has, in a region facing a vibration surface of the piezoelectric detection unit, a surface substantially parallel to the vibration surface.

6. The liquid container according to claim 1,
wherein the moving member is urged by an urging unit in a direction opposite to a direction in which the piezoelectric detection unit is disposed.

7. The liquid container according to claim 6,
wherein the urging unit is formed of an elastic member.

8. The liquid container according to claim 1,
wherein a time at which the moving member forms the closed space in cooperation with the concave portion is set to a state where the liquid of the liquid containing chamber is exhausted.

9. The liquid container according to claim 1,
wherein a time at which the moving member forms the closed space in cooperation with the concave portion is set to a state where the liquid of the liquid containing chamber is nearly exhausted.

10. A liquid container comprising:
a liquid containing chamber storing liquid therein; and
a liquid detection device for detecting a liquid containing amount in the liquid containing chamber, including: a liquid detection chamber that includes a liquid inlet port communicating with the liquid containing chamber and a liquid outlet port communicating with a liquid supply port for supplying the liquid to an external liquid consuming apparatus; and a film defining a part of the liquid detection chamber, and
a pressure port for applying a pressurized fluid to the liquid containing chamber so as to discharge the liquid stored in the liquid containing chamber,
wherein the liquid detection device is arranged in the liquid container such that the pressurized fluid is also applied to the film of the liquid detection chamber.

11. The liquid container according to claim 10, wherein the liquid detection device further includes a moving member that is attached to the film and is movable according to a liquid containing amount in the liquid detection chamber.

12. The liquid container according to claim 11, wherein the moving member is urged by an urging unit in a direction opposite to a direction in which the piezoelectric detection unit is disposed.

13. The liquid container according to claim 12,
wherein the urging unit is formed of an elastic member.

14. A liquid container comprising:
a pressure chamber;
a liquid containing chamber; and
a liquid detection chamber,
wherein each of the liquid detection chamber and the liquid containing chamber is urged so as to reduce its volume due to a pressurized fluid to be introduced in the pressure chamber.
